(19) United States
(12) Patent Application Publication
(10) Pub. No.: US 2003/0214667 A1
(43) Pub. Date: Nov. 20, 2003

(54) Display device and image forming apparatus equipped with the display device

(76) Inventors: Kaoru Ishikura, Kyoto-shi (JP); Shuji Fujii, Soraku-gun (JP); Kenji Takahashi, Yamatokoriyama-shi (JP); Takashi Imai, Nara-shi (JP); Yuji Okamoto, Soraku-gun (JP); Nobuyuki Ueda, Yamatokoriyama-shi (JP)

Correspondence Address: David G. Conlin, Edwards & Angell, LLP, P. O. Box 9169, Boston, MA, 02209, US

(21) Appl. No.: 10/441,641

(22) Filed: May 19, 2003

(30) Foreign Application Priority Data
May 20, 2002 (JP) 2002-144898

(51) Int. Cl. G06F 15/00; B41F 1/00; G06K 1/00

(52) U.S. Cl. 358/1.13

(57) ABSTRACT

An image forming apparatus has a job management unit for reserving a plurality of jobs, and a control panel 7 for concurrently displaying reservation statuses of four jobs among those reserved by the job management unit. A main status area 82a displays reservation statuses of the first three jobs in the queue and a reservation status of the last job which is newly reserved. The reservation status of the newly reserved last job is displayed preferentially in place of that of the fourth job in the queue.

### BACKGROUND OF THE INVENTION

1. Field of the Invention

The invention relates to a display device which displays reservation statuses of more than one processing operation, and also relates to an image forming apparatus such as a copier or a printer equipped with this display device.

2. Related Art

Image forming apparatus of this type are conventionally disclosed in Japanese Patent Laid-open Publication No. Hei 8-194588 and Japanese Patent Laid-open Publication No. 2001-154773, to name a few. Such an image forming apparatus is equipped with a print job display device which shows the process statuses and results of reserved print jobs so that the job rank (order) of a particular print job can be confirmed on request from a user. As shown in FIG. 10, the display device gives a list of job reservation statuses, in response to a user's display request. The number of viewable items depends on the display capacity of the display part.

To be specific, a control panel 7 as shown in FIG. 3 is provided on the top surface of an image forming apparatus 1. The control panel 7 has a display part 7A composed of a touch panel, and a control part 7B. The display part 7A is composed of a liquid crystal display panel and capable of displaying images as well as numbers and symbols. The control part 7B is used to enter instructions about the settings, conditions, processing operations, etc. into the image forming apparatus 1.

The control part 7B includes, for example, numeric keys 71 for entering the number of prints or copies to be created, a start key 72 for starting an image output operation, a clear key 73 for clearing entered information, an all clear key (CA key) 74 for clearing all set conditions, mode selection keys 75 for selecting the copy mode, the printer mode, the facsimile mode or the like, and a job status display key 76 for instructing selective display of the current statuses of image formation jobs.

The display part 7A interchangeably displays a basic screen 81 (see FIG. 11) and a job status screen 82 (see FIG. 10) by the action of an operation display part 6E (see FIG. 2). To change over the screens, a user only needs to press the job status display key 76 on the control panel 7. Then, the operation display part 6E receives this signal and changes the view in the display part 7A.

With regard to these screens, the basic screen 81 permits a user to enter instructions about processing operation conditions in the image forming apparatus 1. By way of example, FIG. 11 depicts the basic screen in the copy mode. This basic screen 81 shows the entire external view of the apparatus and the current state of the apparatus, along with copy condition set keys such as a copy density set key 81a, a copy paper set key 81b, and a copy magnification set key 81c. The job status screen 82 is a screen for confirmation of the statuses of processing operations such as the job reservation statuses in the image forming apparatus 1. As depicted in FIG. 10, the job status screen 82 includes a main status area 82a which shows jobs in the order of implementation, a job list area 82b (a processing operation list area), job mode keys 82c and others. When a job reservation is finalized by manipulation of the control part 7B, details of the reserved job are indicated in the main status area 82a, and contents of this job are shown in the job list area 82b, for example, by an icon. In the main status area 82a shown in FIG. 10, the job information is listed sequentially from the top to the bottom. However, the view in the main status area 82a is not particularly limited to this example. Further, the job information given by the job status screen 82 may include, for example, the user name/operation mode, time, number of prints, and current status.

Due to the restricted display space of the display part 7A, the main status area 82a shows a limited number of jobs at a time (e.g. four jobs in FIG. 10). Up/down keys 82d, provided on the right side of the main status area 82a, enable a user to view a higher- or lower-ranked job which is not shown in the main status area 82a or to select a job to be deleted in the job cancel operation.

The job list area 82b occupies a part of the job status screen 82. When the basic screen 81 overlaps the job status screen 82 as illustrated in FIG. 11, at least the job list area 82b remains visible in the background of the basic screen 81. Namely, when the basic screen 81 overlaps the job status screen 82, a part of the job status screen 82 (i.e. the job list area 82b) is not hidden under the basic screen 81 but constantly visible in the display part 7A which displays the basic screen 81. On the other hand, the rest of the job status screen 82 (i.e. except the job list area 82b) is hidden under the basic screen 81.

Accordingly, with the basic screen 81 at the front, the display part 7A of this control panel can simultaneously display the job list area 82b which briefly shows contents of the job status screen 82. Therefore, while the basic screen 81 is displayed for entry of new instructions into the image forming apparatus 1, contents of previously entered processing operations can be confirmed in the job list area 82b. Eventually, a user can always confirm the current status of the image forming apparatus 1 before making a new entry.

Now, referring to FIG. 12, there is described an operation for canceling a previously reserved job, in particular, a cancel operation effected by selecting a job on the job status screen 82.

First, a user presses the job status display key 76 on the control panel 7 to have a full screen view of the job status screen 82, as shown in FIG. 12(b). Next, using the up/down keys 82d on the job status screen 82, the user selects a job to be canceled. On the delete confirmation screen 83 which pops up on the job status screen 82 as shown in FIG. 12(c), the user touches the YES button. After the basic screen 81 appears in the control panel 7, the user displays the delete confirmation screen 83 again (see FIG. 12(d)) and touches the YES button on the screen to cancel the selected job. FIG. 12 illustrates the case of canceling the first reserved job “1—copy mode.”

In general, display devices which have a function of reserving processing operations or jobs are capable of reserving 10 or more processing operations. Nevertheless, with multiple processing operations being reserved, the screen of the display means (such as the job status screen shown in FIG. 10) fails to indicate the reservation statuses of the fifth and later processing operations. Consequently, a user cannot make onscreen confirmation regarding the reservation status of the processing operation immediately after its entry.

### SUMMARY OF THE INVENTION

The invention is made in view of these issues. An object of the invention is to provide a display device and an image forming apparatus equipped with this display device, in which the display device allows a user to make on-screen confirmation regarding the reservation status of a processing operation immediately after its entry, even if a plurality of processing operations have been already reserved.

In order to achieve this object, the invention provides a solution on the presumption that a display device comprises reservation means for reserving a plurality of processing operations, and display means for concurrently displaying reservation statuses of a predetermined number of processing operations which are reserved by the reservation means. This display device is adapted to display a reservation status of a newly reserved processing operation preferentially, in place of a reservation status of a previously reserved processing operation.

Owing to this feature, even when the number of reserved processing operations exceeds the display capacity of the display means, the reservation status of a newly reserved processing operation is preferentially displayed in the display means in place of the reservation status of a previously reserved processing operation. As a result, a user can confirm the reservation status of a new processing operation on the screen of the display means, immediately after the processing operation is entered.

In particular, the display means may be adapted to preferentially display a reservation status of a newly reserved processing operation and reservation statuses of a predetermined number of low-rank processing operations which immediately precede the newly reserved processing operation in a queue of reserved operations, in place of reservation statuses of high-rank processing operations which precede the low-rank processing operations in the queue. Even if a new processing operation is reserved soon after entry of a former processing operation, this arrangement enables confirmation of the reservation status of the former processing operation.

Further, the display means may be adapted to display a reservation status of a newly reserved processing operation preferentially in place of a reservation status of a previously reserved processing operation, while displaying an entry screen which permits entry of conditions for a processing operation. With this arrangement, immediately after a user enters conditions for a processing operation by means of the entry instruction screen which permits such entry, the user can easily see the reservation status of the user's processing operation.

Moreover, the display device may be adapted to display reservation numbers of the reserved processing operations along with their reservation statuses, the reservation statuses being numbered in the order in which the processing operations are reserved. While the reservation statuses are displayed, this arrangement enables a user to see the reservation order of the user's processing operation and thereby to acknowledge its reservation status properly.

In addition, the display device may be adapted to display cancel means for suspending or clearing a reserved processing operation. Owing to this arrangement, even if a user selects the cancel means by accident, the job cancel screen pops up as a measure to prevent an accidental cancel operation. Besides, if a user wishes to cancel a processing operation which is reserved wrongly, it is easily possible to cancel the reserved processing operation by selecting the cancel means and thereby causing the job cancel screen to appear.

An image forming apparatus of the invention comprises a display device of the invention. Even though the space allotted for the screen of the display means is limited in the image forming apparatus, this image forming apparatus enables a user to make on-screen confirmation regarding the reservation status of a newly reserved processing operation. Accordingly, it is possible to make effective use of the display area of the display means.

### BRIEF DESCRIPTION OF THE DRAWINGS

FIG. 1 is a schematic view showing the internal structure of an image forming apparatus according to a first embodiment of the invention.

FIG. 2 is a block diagram which represents the configuration of a control system of the image forming apparatus according to the first embodiment of the invention.

FIG. 3 shows a control panel of the image forming apparatus according to the first embodiment of the invention.

FIG. 4 shows a basic screen displayed in the display part of the image forming apparatus according to the first embodiment of the invention.

FIG. 5 shows a job status screen displayed in the display part of the image forming apparatus according to the first embodiment of the invention.

FIG. 6 is a flowchart showing a process for confirming a newly reserved job in the image forming apparatus according to the first embodiment of the invention.

FIGS. 7(a) to (c) illustrate a series of views which change in the display part of the control panel while a newly reserved job is confirmed in the image forming apparatus according to the first embodiment of the invention.

FIGS. 8(a) to (d) illustrate a series of views which change in the display part of the control panel while a newly reserved job is canceled in the image forming apparatus according to the first embodiment of the invention.

FIGS. 9(a) to (c) illustrate a series of views which change in the display part of the control panel while a newly reserved job is canceled in an image forming apparatus according to a second embodiment of the invention.

FIG. 10 shows a job status screen which appears in the display part of a control panel according to a conventional example.

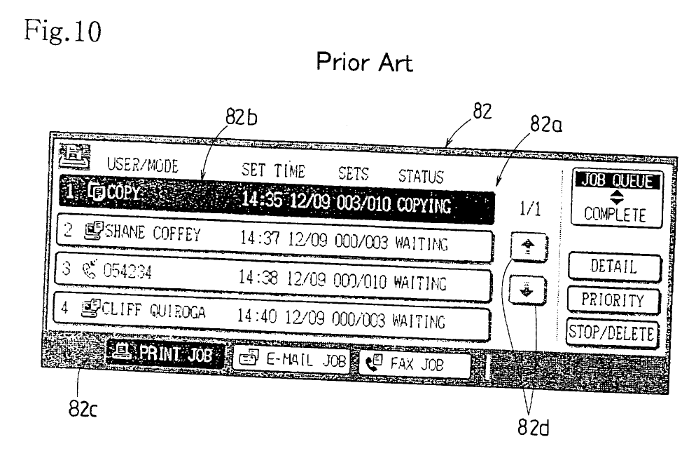

FIG. 11 shows a basic screen which appears in the display part of the control panel according to the conventional example.

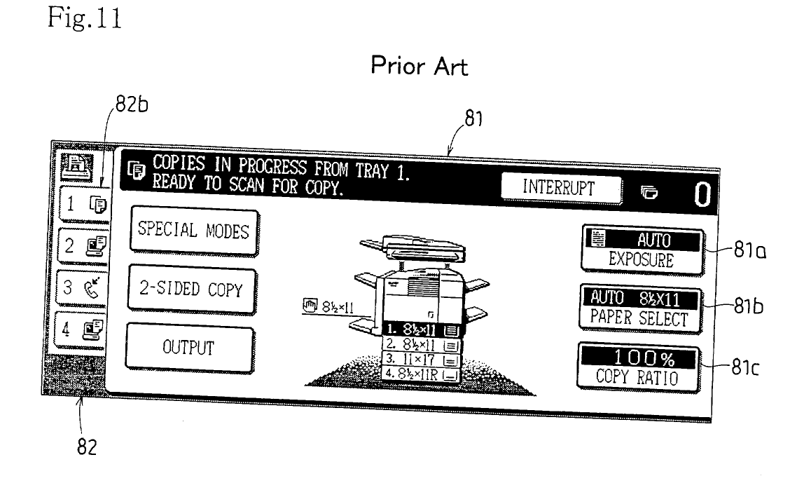

FIGS. 12(a) to (d) illustrate a series of views which change in the display part of the control panel while a job is canceled on the job status screen according to the conventional example.

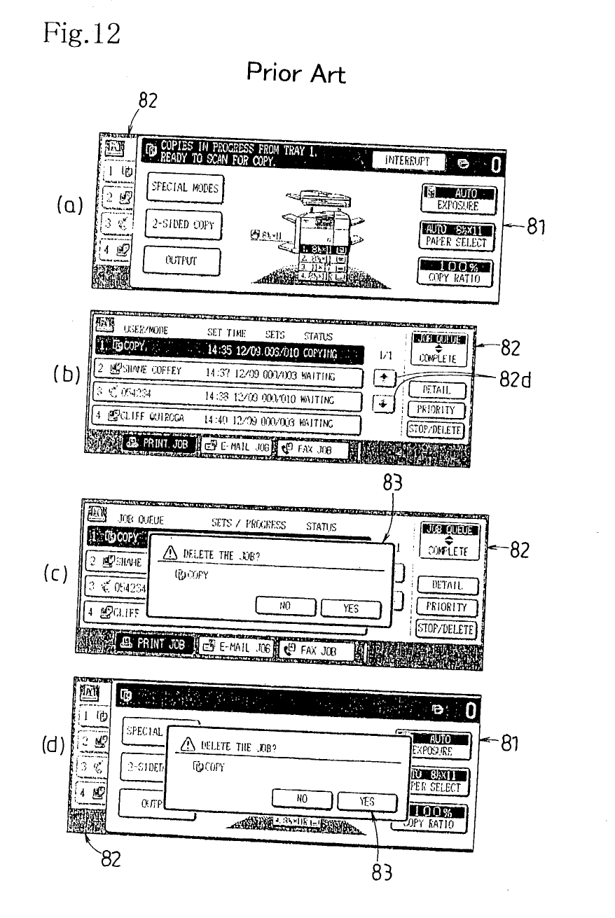

### DESCRIPTION OF THE PREFERRED EMBODIMENTS

Embodiments of the invention are hereinafter described with reference to drawings.

In the following embodiments, the invention is applied to a multifunction digital image forming apparatus which includes a copy mode, a facsimile mode and a printer mode.

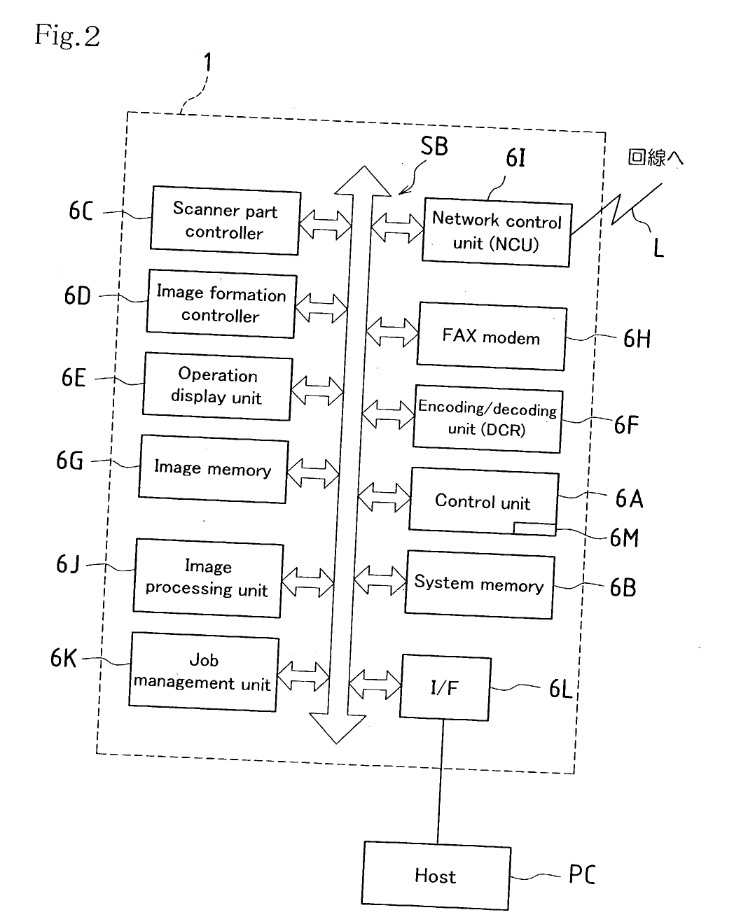

The image forming apparatus 1 of the invention involves a plurality of process modes as mentioned above. As illustrated in FIG. 2, the image forming apparatus 1 is connected with a personal computer (host computer) PC and a telephone line L, thereby being capable of sending and receiving image data and the like to and from the personal computer PC and the telephone line L.

<First Embodiment>

To begin with, a first embodiment of the invention is described.

Entire Structure of the Image Forming Apparatus 1

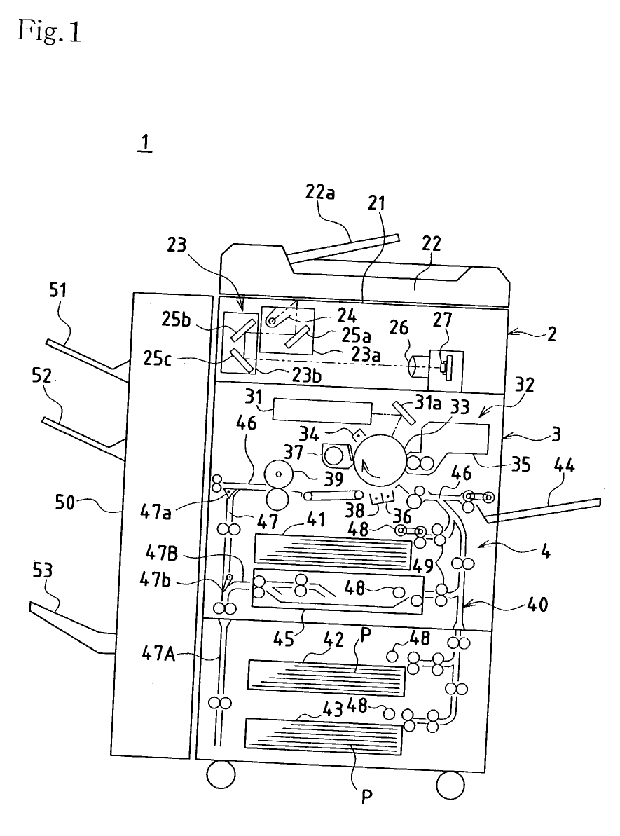

FIG. 1 is a schematic view showing the internal structure of the image forming apparatus 1 according to this embodiment. As illustrated, the image forming apparatus 1 comprises a scanner part 2 (image data acquisition means), an image formation part 3 (image output means) which forms an image on recording paper P (a recording medium), and a paper feed mechanism 4 which delivers recording paper P to the image formation part 3. Each of these elements is detailed below.

<Scanner Part 2>

The scanner part 2 is composed of a document glass 21 made of a transparent glass or the like, and a reversing automatic document feeder (RADF) 22 which feeds an original across the document glass 21. The scanner part 2 scans the image of the original on the document glass 21 and creates its image data.

The RADF 22 has an automatic paper feed tray 22a for holding multiple sheets of originals and automatically feeding them one sheet after another. The RADF 22 allows either or both sides of each original to be scanned by a scanner unit 23 (mentioned later), according to the user's choice. In this connection, the RADF 22 includes a feed path for carrying an original from the automatic paper feed tray 22a to the document glass 21, and a reversing path for reversing an original so that both sides of the original can be scanned by the scanner unit 23. For single-side scanning, an original simply passes the feed path. For double-side scanning, an original also passes the feed path and travels across the document glass 21, but the original is then reversed in the reversing path and brought back to the document glass 21. For this purpose, each of these paths is provided with feed path switchover means (not shown) and a group of sensors (not shown) for sensing the travel position of an original. The structure of the RADF 22, which is already known well, is not detailed herein.

The scanner part 2 also contains a scanner unit 23 for scanning an image of an original carried across the document glass 21. The scanner unit 23 has a lamp reflector assembly 24, a plurality of reflecting mirrors 25a, 25b, 25c, an optical lens 26, and an optical-electrical converter (CCD) 27.

The lamp reflector assembly 24 irradiates an original placed on the document glass 21. The reflecting mirrors 25a, 25b, 25c are disposed such that light reflected from the original follows the light path outlined by the two-dot chain line in FIG. 1. In the drawing, the reflected light is directed first to the left, then downward, and finally to the right toward the optical lens 26.

An image scan operation of an original is conducted in the following manner. When an original is placed on the document glass 21, a first scanning unit 23a composed of the lamp reflector assembly 24 and the reflecting mirror 25a scans horizontally across the document glass 21, irradiating the original entirely. At the same time, a second scanning unit 23b composed of the reflecting mirrors 25b, 25c also travels horizontally, at a certain speed relative to the first scanning unit 23a (half as fast as the first scanning unit 23a). After reflected by the reflecting mirrors 25a, 25b, 25c and transmitted through the optical lens 26, light focuses on the optical-electrical converter 27, where the reflected light is converted into an electric signal (image data of the original). The image data is sent to an image processing unit 6J (to be mentioned, see FIG. 2) and subjected to various processing. The processed image data is temporarily stored in an image memory 6G. Later, in response to an output command, the image data stored in the image memory 6G is fetched and used for an image formation operation in the image formation part 3.

<Image Formation Part 3>

The image formation part 3 includes a laser writing unit 31 and an electrophotography processing part 32. The laser writing unit 31 irradiates the surface of a photosensitive drum 33 which is provided in the electrophotography processing part 32. Irradiation of a laser beam is based on original's image data converted in the optical-electrical converter 27 as above, image data sent from the personal computer PC, or the like. To be specific, the laser writing unit 31 contains a semiconductor laser source which emits a laser beam according to the image data, a polygon mirror which deflects the laser beam at a uniform angular velocity, and an f-theta lens which corrects the thus deflected laser beam in such a manner as to be deflected on the photosensitive drum 33 at a uniform angular velocity.

The photosensitive drum 33 rotates in the arrow's direction shown in FIG. 1. The surface of the photosensitive drum 33 is irradiated by a laser beam which is emitted from the laser writing unit 31 and reflected by a reflecting mirror 31a. Thereby, an electrostatic latent image is formed on the drum surface.

The electrophotography processing part 32 is composed of a charger 34, a developer 35, a transfer apparatus 36, a static eliminator 38, and a scraper/cleaner 37, all of which are disposed around the photosensitive drum 33. In addition, the electrophotography processing part 32 is equipped with a fuser 39. The charger 34 charges the surface of the photosensitive drum 33 at a predetermined potential, prior to formation of an electrostatic latent image. The developer 35 develops the electrostatic latent image formed on the drum surface, thereby producing a visible toner image (toner is an image formation material). The transfer apparatus 36 transfers the toner image from the drum surface to recording paper P. Once the toner image is transferred to the recording paper P, the fuser 39 fixes the toner image on the recording paper P by heating. The static eliminator 38 removes residual charges from the drum surface. After the toner transfer, the scraper/cleaner 37 removes residual toner from the drum surface.

To form an image on recording paper P, the charger 34 charges the surface of the photosensitive drum 33 at a predetermined potential. Then, the laser writing unit 31 irradiates the drum surface with a laser beam based on image data, thereby forming an electrostatic latent image. Thereafter, the developer 35 develops the electrostatic latent image, producing a visible toner image on the drum surface. Next, the transfer apparatus 36 transfers the toner image to recording paper P which is fed from the paper feed mechanism 4. Later, the fuser 39 heats the recording paper P, so that the toner image is fixed on the paper. Further, after the toner transfer, residual charges 33 on the drum surface are neutralized by the static eliminator 38 and residual toner on the drum surface is removed by the scraper/cleaner 37. The toner removal step concludes a cycle of the image formation operation (the printing operation) to the recording paper P. Repetition of this cycle enables successive image formation on multiple sheets of recording paper P.

<Paper Transport Mechanism 4>

In connection with the above image formation operation by the image formation part 3, the paper feed mechanism 4 feeds recording paper P one sheet after another, from a first, second or third paper cassette 41, 42, 43 or from a multi-purpose manual feed tray 44. After an image is formed on the recording paper P, the paper feed mechanism 4 outputs the paper to a first, second or third output bin 51, 52, 53. Further, the paper feed mechanism 4 is equipped with a duplex copying unit 45. The duplex copying unit 45 collects the recording paper P after an image is formed on one side, and returns the collected sheet to the image formation part 3 in order to form an image on the other side.

The paper cassettes 41, 42, 43 load recording paper P of different sizes. According to the paper size required by the user, the recording paper P is pulled out one sheet after another from a suitable paper cassette and carried through a feed path 40 to the image formation part 3.

The feed path 40 in the paper feed mechanism 4 is constituted with a main feed passage 46 and a reversing feed passage 47.

As for the main feed passage 46, one end (the upstream end along the recording paper feed direction) divides into branches which face the exit side of the cassettes 41, 42, 43 and the manual feed tray 44, respectively. The main feed passage 46 continues along the transfer apparatus 36 and the fuser 39, with the other end (the downstream end along the recording paper feed direction) opposed to a finisher 50 which is equipped with the output bins 51, 52, 53.

As for the reversing feed passage 47, one end (the upper end in the drawing) joins the main feed passage 46, with the joint locating downstream of the fuser 39 (in the drawing, to the left of the fuser 39). The reversing feed passage 47 divides halfway (in the drawing, at the middle in the vertical directions) into first and second branches 47A, 47B. The first branch 47A perpendicularly extends to the bottom, whereas the second branch 47B terminates opposite to the entrance side of the duplex copying unit 45.

A first branch pawl 47a locates at the joint between the main feed passage 46 and the reversing feed passage 47. A second branch pawl 47b locates at the branch point of the reversing feed passage 47.

The first branch pawl 47a is freely rotatable around a horizontal axis, between the first position for closing the reversing feed passage 47 and the second position for closing the exit end of the main feed passage 46 and establishing communication between the main feed passage 46 and the reversing feed passage 47. As far as the first branch pawl 47a stays at the first position, the recording paper P coming out of the image formation part 3 is guided straight to the output bin 51, 52 or 53. On the other hand, while the first branch pawl 47a stays at the second position, the recording paper P coming out of the image formation part 3 is directed into the reversing feed passage 47.

The second branch pawl 47b in the reversing feed passage 47 is freely rotatable around a horizontal axis, between the first position for opening the first branch 47A and closing the second branch 47B, and the second position for opening the second branch 47B and closing the first branch 47A. When the second branch pawl 47b locates at the first position, the recording paper P brought into the reversing feed passage 47 is guided to the bottommost position of the first branch 47A. Next, the second branch pawl 47b shifts to the second position, and the feed direction of the recording paper P is reversed. Then, the recording paper P travels through the branch point and the second branch 47B and enters the duplex copying unit 45. Namely, owing to the arrangement in which the recording paper P travels through the first branch 47A and the second branch 47B and enters the duplex copying unit 45, the recording paper P is supplied upside down to the image formation part 3. With the recording paper P reversed, it is possible to form an image on the other side of the recording paper P.

Pick up rollers 48 are disposed at the upstream ends of the main feed passage 46 (the ends opposite to the exit side of the paper cassettes 41, 42, 43, the manual feed tray 44 and the duplex copying unit 45). A plurality of feed rollers 49 locate downstream of each pick-up roller 48, in order to feed the picked-up recording paper P into the main feed passage 46. With rotations of any pick-up roller 48 and the associated feed rollers 49, the recording paper P is selectively pulled out one sheet after another from the paper cassette 41, 42, 43, the manual feed tray 44 or the duplex copying unit 45, and supplied into the main feed passage 46.

As mentioned already, the output part of the image forming apparatus 1 is composed of the first and second output bins 51, 52 which are vertically disposed in two tiers, and the third output bin 53 equipped with a staple finisher (built inside the finisher 50 and not shown). The finisher 50 includes output passages which connect the downstream end of the main feed passage 46 and the output bins 51, 52, 53. The output passages are switchable according to the output bins 51, 52, 53 from which the recording paper P should come out.

<Configuration of the Control System>

FIG. 2 is a block diagram which represents the configuration of a control system in the image forming apparatus 1. As illustrated, the image forming apparatus 1 comprises a control unit 6A, a system memory 6B, a scanner part controller 6C, an image formation controller 6D, an operation display unit 6E as a display device, an encoding/decoding unit 6F, an image memory 6G, a facsimile modem 6H, a network control unit 6I, an image processing unit 6J, a job management unit 6K as reservation means, and a communication interface 6L. These constituents are connected to a system bus SB for mutual transmission and receipt of data.

The control unit 6A is what is called a CPU (Central Processing Unit). By sending and receiving data signals and control signals to and from the means which constitute the image forming apparatus 1 (namely, the scanner part 2, the image formation part 3, and the paper feed mechanism 4), the control unit 6A has total control over the copy, print and other operations, and also controls facsimile transmissions including a circulation/transfer function.

The system memory 6B is composed of a ROM (Read Only Memory) and a RAM (Random Access Memory). The system memory 6B stores control processing programs to be executed by the control unit 6A, as well as various data and the like required for execution of these programs. Further, the system memory 6B constitutes a work area in the control unit 6A.

The scanner part controller 6C controls the scan operation in the scanner part 2.

The image formation controller 6D controls the image formation operation in the image formation part 3.

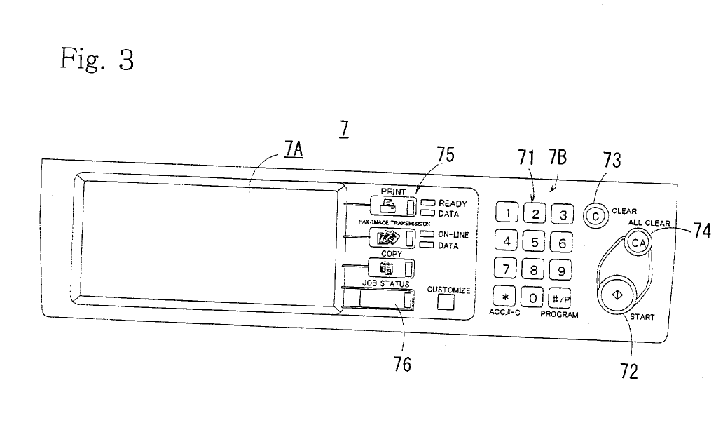

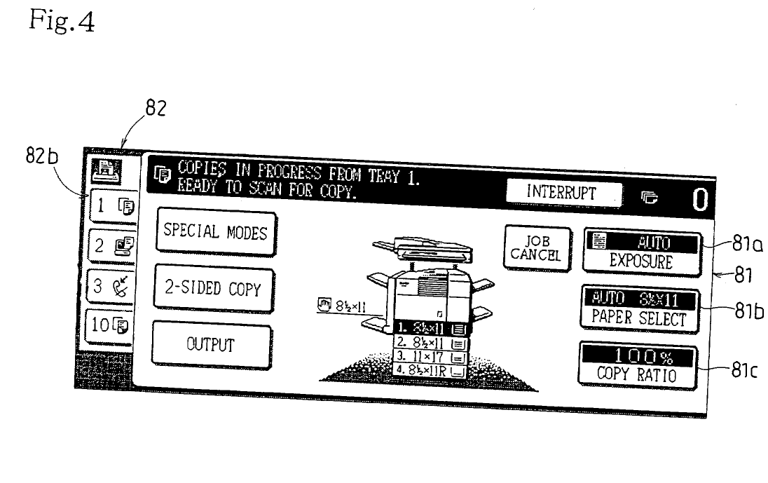

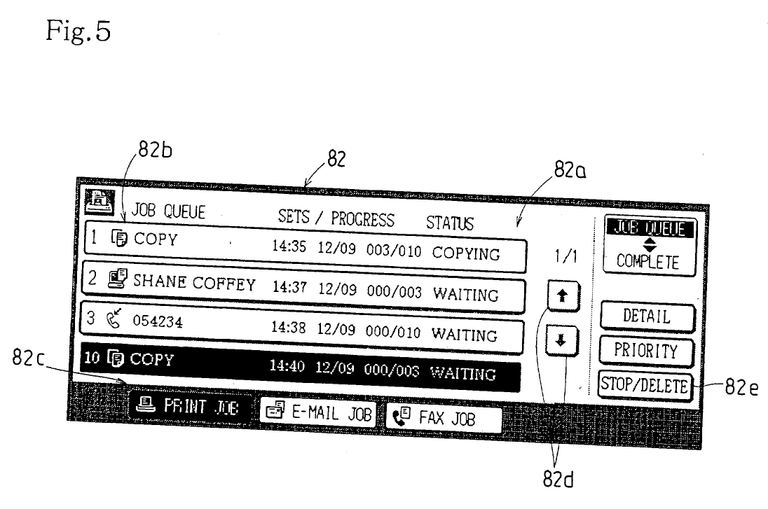

The operation display unit 6E controls the view in the control panel 7 (see FIG. 3) which is provided, as the display means, at the top of the image forming apparatus 1. Besides, the operation display unit 6E receives an operation signal when a user manipulates a key on the control panel 7. In particular, when the job status display key 76 is pressed on the control panel 7, the operation display unit 6E is adapted to change the view in the display part 7A of the control panel 7, between the basic screen 81 (see FIG. 4) and the job status screen 82 (see FIG. 5). The arrangement of the control panel 7 and details of its view changing operation are discussed later.

The encoding/decoding unit 6F compresses and encodes an image signal, and decodes the compressed and encoded image signal back to the original image signal.

The image memory 6G temporarily stores the image signal which is compressed and encoded in the encoding/decoding unit 6F.

The facsimile modem 6H realizes a modem function for G3 facsimile. It has a low-speed modem function for sending and receiving transmission procedure signals and a high-speed modem function for mainly sending and receiving image information.

The network control unit 6I connects the facsimile modem 6H to the public switched telephone network, and has an auto dial/auto answer function.

The image processing unit 6J subjects the image data stored in the image memory 6G to compression, decompression, rotation, scaling and other processes.

The job management unit 6K manages the reservation statuses of jobs when more than one user submits a run command. On receiving run commands of a plurality of jobs, the job management unit 6K stores the process mode and various conditions (print conditions, etc.) of each job in the memory, in the order of reservation. Then, the job management unit 6K controls execution of the respective processing operations, with changing the process modes according to this reservation order.

The communication interface 6L is communication interface means for accepting image data from the personal computer PC. In response to a print request submitted from the personal computer PC (on receiving print job information) the communication interface 6L executes the image formation operation, based on the information.

The basic operations of the thus configured image forming apparatus 1 are summarized below. For the copy operation, the image formation apparatus 1 scans the image of an original and forms the image on the recording paper P, as mentioned already. For the print operation, the image forming apparatus 1 receives print data (image data) from the personal computer PC and prints out the data. The image forming apparatus 1 can also function as a scanner. For the scan operation, the image forming apparatus 1 scans the image of an original placed on the document glass 21 and sends scanned image data to the personal computer PC. For the facsimile transmission operation, the image formation apparatus 1 scans the image of an original by the scanner part 2 and outputs facsimile image data via the facsimile modem 6H and the network control unit 6I, to the telephone line L. For the facsimile receiving operation, the image formation apparatus 1 receives facsimile image data via the telephone line L and prints out the data by the image formation part 3. Thus, the image forming apparatus 1 is a multifunction product which serves, for example, as a copier, facsimile, printer and scanner, and preferably as an Internet facsimile which exchanges information via e-mail. This image forming apparatus 1 interacts with various data processors on the network.

As a feature of this embodiment, the control unit 6A contains a processing operation changing unit 6M as processing operation changing means. The processing operation changing unit 6M changes the processing operation to be triggered by depression of the all clear key 74 on the control panel, depending on the operation status of the image forming apparatus 1.

Specifically, the processing operation to be triggered by depression of the all clear key 74 is determined by whether or not the image data read-in operation is in progress in the image forming apparatus 1. If not, the processing operation is further determined by whether or not the process mode is the copy mode. To give some specific examples, suppose that the all clear key 74 is pressed in the midst of the image data read-in operation, the read-in operation is forced to end immediately, followed by termination of an ongoing process mode. In another case, suppose that the all clear key 74 is pressed while the image forming apparatus 1 is not currently performing the image data read-in operation but in the copy mode. In this situation, if the image forming operation is in progress at the image formation part 3, the image forming operation is suspended temporarily. Otherwise, an ongoing processing operation is allowed to continue, with depression of the all clear key 74 being ignored. In yet another case, suppose that the all clear key 74 is pressed while the image forming apparatus 1 is neither currently performing the image data read-in operation nor in the copy mode. Also in this situation, an ongoing processing operation is allowed to continue, with depression of the all clear key 74 being ignored.

Additionally, when the image forming operation is suspended temporarily, the processing operation changing unit 6M displays a confirmation message in the display part 7A of the control panel 7, in order to let a user confirm whether to execute the processing operation triggered by manipulation of the all clear key 74.

After the output of this confirmation message, if no confirmation is made by the user within a predetermined time, the processing operation changing means 6M cancels manipulation of the all clear key 74 and resumes the image forming operation which has been suspended temporarily.

The processing operation effected by the processing operation changing means 6M is detailed later with reference to a flowchart.

In this embodiment, the processing operation to be triggered by depression of the all clear key 74 is arranged to change depending on the operation status of the image forming apparatus 1. Alternatively, the processing operation to be triggered by depression of the clear key 73 may be arranged to change depending on the operation status of the image forming apparatus 1. As additional arrangements, it is possible to change the processing operation to be triggered by depression of whichever of the all clear key 74 or the clear key 73 or to change the processing operation to be triggered by depression of any other key, depending on the operation status of the image forming apparatus 1.

<Control Panel>

FIG. 3 shows the control panel 7 which is provided on the top of the image forming apparatus 1. As illustrated, the control panel 7 has a display part 7A and a control part 7B. The display part 7A is composed of a liquid crystal display panel and capable of displaying images as well as numbers and symbols. Preferably, the display part 7A is made of a touch panel. A touch panel structure facilitates entry operations and simplifies the key arrangement and the structure of the control part 7B.

The control part 7B is used to enter instructions about the settings, conditions, processing operations, etc. into the image forming apparatus 1. The control part 7B includes, for example, numeric keys 71 for entering the number of prints or copies to be created, a start key 72 for starting an image output operation, a clear key 73 for clearing entered information, an all clear key (CA key) 74 for clearing all set conditions, mode selection keys 75 for selecting the copy mode, the printer mode, the facsimile mode or the like, and a job status display key 76 for instructing selective display of the current statuses of image formation jobs.

The display part 7A interchangeably displays a basic screen 81 (see FIG. 4) and a job status screen 82 (see FIG. 5) by the action of the operation display part 6E. To change over the screens, a user only needs to press the job status display key 76 on the control panel 7. Then, the operation display part 6E receives this signal and changes the view in the display part 7A. These screens are described below.

The basic screen 81 permits a user to enter instructions about processing operation conditions in the image forming apparatus 1. By way of example, FIG. 4 depicts the basic screen in the copy mode. This basic screen 81 shows the entire external view of the apparatus and the current state of the apparatus, along with copy condition set keys such as a copy density set key 81a, a copy paper set key 81b, and a copy magnification set key 81c.

The job status screen 82 is a screen for confirmation of the statuses of processing operations such as the job reservation statuses in the image forming apparatus 1. As depicted in FIG. 5, the job status screen 82 includes a main status area 82a which shows four jobs, a job list area 82b (a processing operation list area), job mode keys 82c and others. When a job reservation is finalized by manipulation of the control part 7B, details of the reserved job are indicated in the main status area 82a, and contents of this job are shown in the job list area 82b, for example, by an icon.

The main status area 82a is arranged to display the reservation statuses of the first three jobs (the three highest-ranked jobs) in the queue as well as the reservation status of the last job which is newly reserved. The reservation status of the last job comes up preferentially, in place of the reservation status of the fourth job in the queue. The job information shown on the job status screen 82 may include, for example, the reservation number which indicates the order of reserved processing operations, user name/operation mode, time, number of prints, and current status.

Due to the restricted display space of the display part 7A, the main status area 82a shows only four jobs at a time, but this should be understood as a non-limitative example. Up/down keys 82d, provided on the right side of the main status area 82a, enable a user to view a higher- or lower-ranked job which is not shown in the main status area 82a or to select a job to be deleted in the job cancel operation.

The job list area 82b occupies a part of the job status screen 82. When the basic screen 81 overlaps the job status screen 82 as illustrated in FIG. 4, at least the job list area 82b remains visible in the background of the basic screen 81. Namely, when the basic screen 81 overlaps the job status screen 82, a part of the job status screen 82 (i.e. the job list area 82b) is not hidden under the basic screen 81 but constantly visible in the display part 7A which displays the basic screen 81. On the other hand, the rest of the job status screen 82 (i.e. except the job list area 82b) is hidden under the basic screen 81.

Accordingly, with the basic screen 81 at the front, the display part 7A of this control panel can simultaneously display the job list area 82b which briefly shows contents of the job status screen 82. Therefore, while the basic screen 81 is displayed for entry of new instructions into the image forming apparatus 1, contents of previously entered processing operations can be confirmed in the job list area 82b. Eventually, a user can always confirm the current status of the image forming apparatus 1 before making a new entry.

—Operations Related to Job Entry

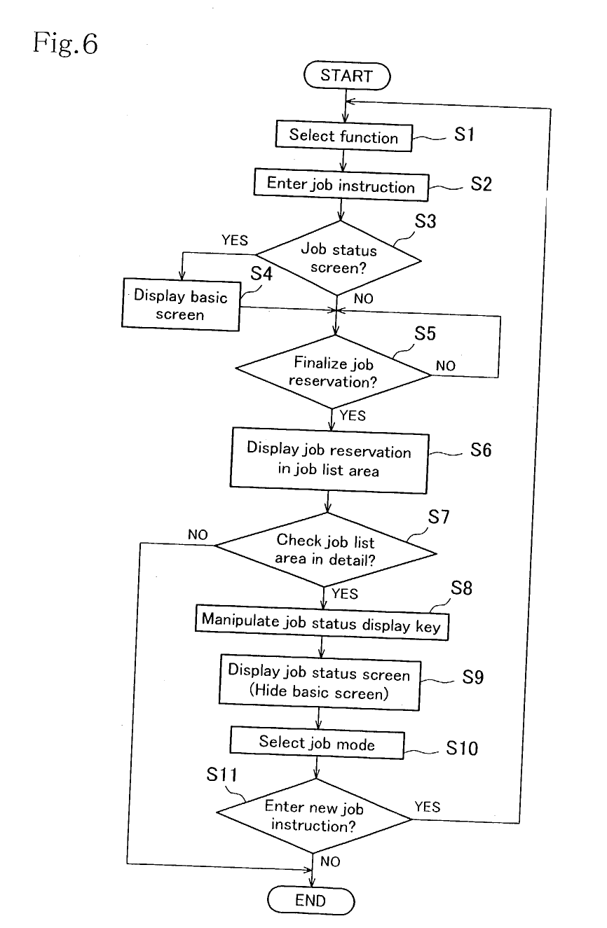

The flowchart in FIG. 6 shows a process for confirming a reserved job which is newly entered.

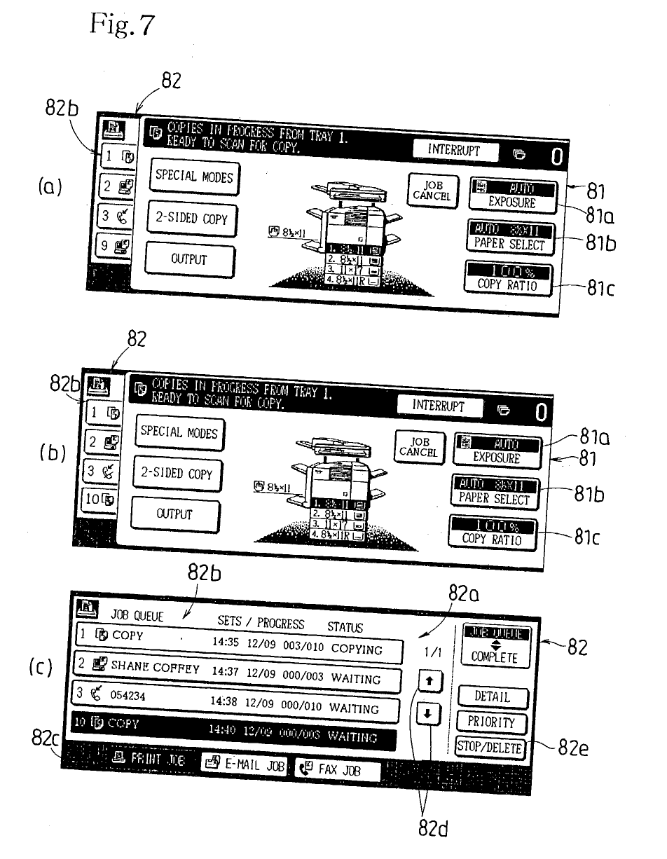

To start with, a user selects a function in Step S1 as shown in the flowchart of FIG. 6. Next in Step S2, the user instructs conditions for a new processing operation (i.e. enters instructions for a new job) in the image forming apparatus 1. At this moment, the bottommost bar in the job list area 82b, which remains visible in the background of the basic screen 81, indicates a job (“9—printer mode” in FIG. 7(a)) which is ranked last until the instructions for the new job are given.

Step S3 determines whether the job status screen 82 is at the front in the display part 7A of the control panel. If the job status screen 82 is at the front (YES in Step S3), the operation proceeds to Step S4 where the view in the display part 7A of the control panel 7 is changed from the job status screen 82 to the basic screen 81 (see FIG. 4), by manipulation of the job status display key 76 on the control panel 7. After the basic screen 81 appears at the front, the operation continues to Step S5. If the basic screen 81 is already at the front in Step S3 (NO in Step S3) the operation goes from Step S3 to Step S5.

The operation stands by at Step S5 until the job reservation is finalized. Thereafter in Step S6, the new job is displayed in the job list area 82b which remains visible in the background of the basic screen 81. As shown in FIG. 7(b), the new job “10—copy mode” appears in the bottommost bar of the job list area 82b, instead of the job “9—printer mode” which is one job ahead in the queue.

Step S7 judges whether the job list area 82b in the job status screen 82 should be checked in detail or not. For example, Step S7 judges whether the job list area 82b should be displayed as a whole, in the case where the job list area 82b is hard to see for confirmation. If the user can confirm the reservation well by checking the job list area 82b which remains visible in the background of the basic screen 81 (NO in Step S7), the job confirmation operation ends immediately.

On the other hand, if the user cannot confirm the reservation enough by simply checking the job list area 82b which remains visible in the background of the basic screen 81 (YES in Step S7), the user manipulates the job status display key 76 on the control panel 7 (Step S8). Thereby, the view of the display part 7A of the control panel 7 changes from the basic screen 81 to the job status screen 82 shown in FIG. 7(c) (Step S9) On this job status screen 82, the user selects a job mode to be confirmed (Step S10).

Later, Step 11 judges whether a next job is entered in the image forming apparatus 1. If YES, the operation returns to Step S1. Otherwise, the job confirmation operation comes to an end.

As cancel means for suspending or clearing a reserved job, a stop/delete key 82e is shown at the bottom right of the job status screen 82.

In this connection, an operation for canceling a newly reserved job is now mentioned.

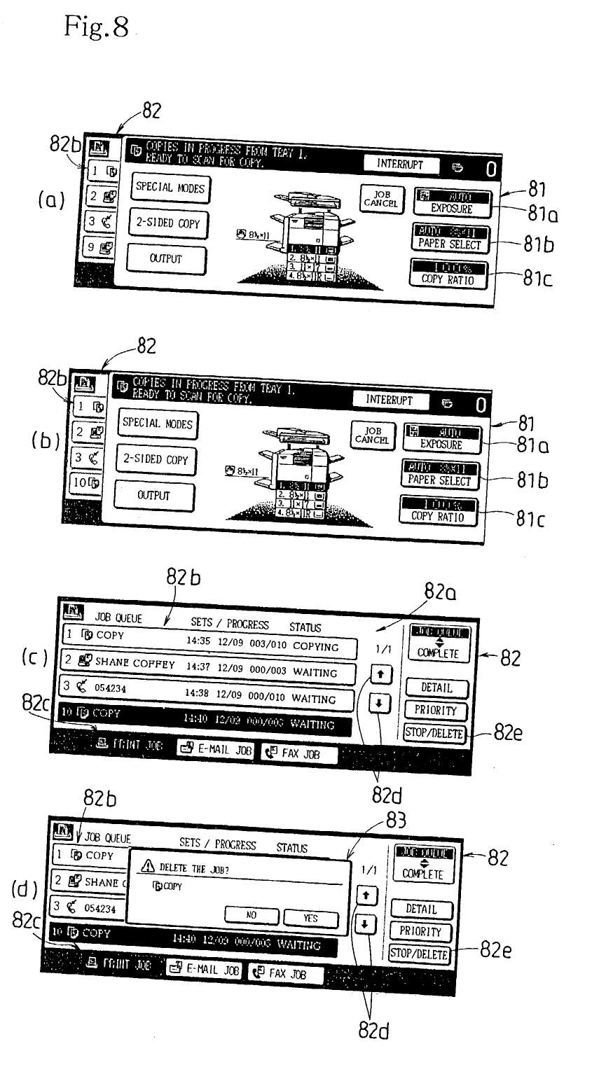

Referring to FIG. 8(a), the basic screen 81 overlaps the job status screen 82, except the job list area 82b. With a new job entry, the new job “10—copy mode” is reserved and indicated in the bottommost bar in the job list area 82b, as shown in FIG. 8(b). To cancel this job, a user presses the job status display key 76 on the control panel 7 to have a full screen view of the job status screen 82, as shown in FIG. 8(c). Next, using the up/down keys 82d on the job status screen 82, the user selects a job to be canceled. Then, the user touches the stop/delete key 82e, causing the delete confirmation screen 83 (a job cancel screen) to pop up on the job status screen 82 as shown in FIG. 8(d). On this delete confirmation screen 83, the user touches the YES button, thereby canceling the selected job. FIG. 8 illustrates the case of canceling the newly reserved job “10—copy mode” in the fourth bar.

According to this embodiment, even if the number of reserved jobs exceeds the display capacity (four at a time) of the job status screen 82 in the display part 7A of the control panel 7, the reservation status of a newly reserved job preferentially appears in the bottommost bar of the job list area 82b, in place of the reservation status of the fourth job in the queue. Thus, on entry of a new job, a user can confirm its reservation status immediately on the job status screen 82.

Besides, the display device of this embodiment displays the reservation status of a newly reserved job preferentially in place of the reservation status of a previously reserved job, while displaying the entry screen which permits entry of conditions for a processing operation. Hence, immediately after a user enters conditions for a processing operation by means of the basic screen 81, the user can easily see the reservation status of the user's job.

Further, the job list area 82b of the job status screen 82 shows reservation numbers which are numbered in the order in which the jobs are reserved. Whichever of the basic screen 81 or the job status screen 82 is displayed at the front, a user can see the reservation order of the user's job and can acknowledge its reservation status properly.

Furthermore, the job status screen 82 displays the stop/delete key 82e for suspending or clearing a reserved processing operation. Even if a user touches the stop/delete key 82e by accident, the delete confirmation screen 83 pops up as a measure to prevent an accidental cancel operation. Besides, if a user wishes to cancel a wrongly reserved job, it is easily possible to cancel the reserved job by touching the stop/delete key 82e and thereby causing the delete confirmation screen 83 to appear.

In addition, in the image forming apparatus 1 equipped with this operation display part 6E, the reservation status of a newly reserved job can be confirmed in the job status screen 82 in the display part 7A of the control panel 7, even though the space allotted for the screen is limited in the image forming apparatus 1. Accordingly, it is possible to make effective use of the display area in the display part 7A of the control panel 7.

(Second Embodiment)

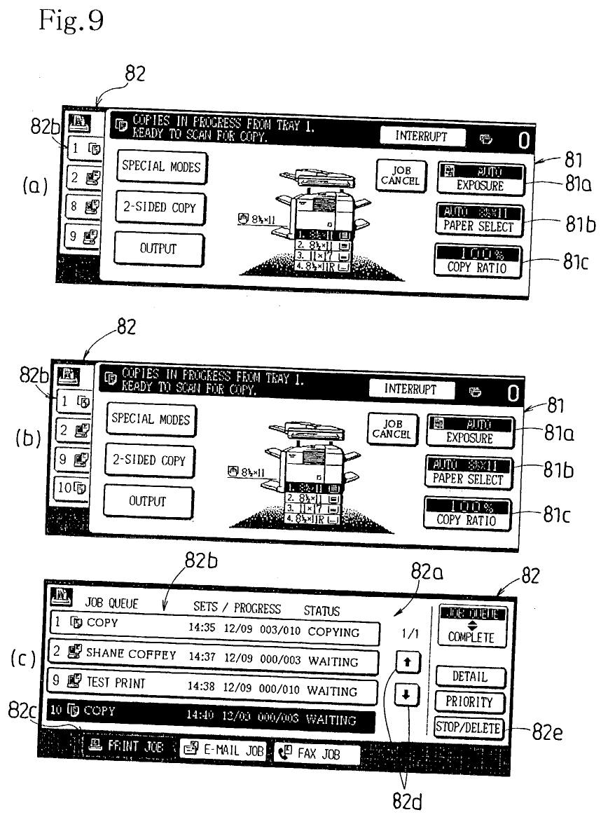

Referring next to FIGS. 9(a)-(c), the second embodiment of the invention is described.

The second embodiment modifies the view in the job status screen 82 in the display part 7A of the control panel 7. Except for the view in the job status screen 82 in the display part 7A, this embodiment is similar to the first embodiment, and the same constituents are identified by the same signs and not mentioned in detail.

FIG. 9(a) depicts the display part 7A of the control panel 7. The main status area 82a in the job status screen 82 displays, at the top left part, the reservation statuses of the first two jobs (the two highest-ranked jobs) in the queue. In addition, the bottom left part of the main status area 82a displays the reservation status of the last job “9—printer mode” as well as the reservation status of the second last job “8-printer mode” which is one job ahead in the queue. The reservation statuses of the last two jobs are displayed preferentially in place of the reservation statuses of the third and fourth jobs in the queue.

Turning to FIGS. 9(b) and (c), when a new job is reserved in the image forming apparatus 1, the reservation status of the new job “10—copy mode” which is the last (i.e. ranked lowest) in the queue appear in the bottommost bar of the job list area 82b, in place of the reservation status of a job “9—printer mode.” In turn, the reservation status of the job “9—printer mode” which is now second last in the queue takes the place of the reservation status of the job “8—printer mode.” To put it simply, whenever a new job is reserved in the image forming apparatus 1, the reservation statuses of the last and second last jobs are preferentially displayed at the bottom left part, in place of the reservation statuses of the third and fourth jobs in the queue.

If a new processing operation is reserved immediately after entry of a former processing operation, the first embodiment cannot show the reservation status of the former job. To make up this inconvenience, the second embodiment is arranged to display the reservation statuses of the last job and the second last job preferentially in the main status area 82a, thereby allowing a user to confirm the job reservation statuses under such circumstances.

In the embodiments as above described, the invention is applied to a multifunction digital image forming apparatus which includes a copy mode, a facsimile mode and a printer mode. Nevertheless, the invention should not be limited to this type of apparatus, but is applicable to other types of image forming apparatus. The invention may be embodied in other specific forms without departing from the spirit or essential characteristics thereof. The above embodiments are therefore to be considered in all respects as illustrative and not restrictive, the scope of the invention being indicated by the appended claims rather than by the foregoing description. All changes which come within the meaning and range of equivalency of the claims are therefore intended to be embraced therein.

This application is based on Patent Application No. 2002-144898 filed in Japan, the contents of which are incorporated hereinto by reference. Likewise, the contents of all references cited herein are incorporated hereinto by reference.

What is claimed is:

1. A display device which comprises reservation means for reserving a plurality of processing operations, and display means for concurrently displaying reservation statuses of a predetermined number of processing operations which are reserved by the reservation means,
the display means being adapted to display a reservation status of a newly reserved processing operation preferentially, in place of a reservation status of a previously reserved processing operation.

2. The display device according to claim 1, wherein the display means is adapted to preferentially display a reservation status of a newly reserved processing operation and reservation statuses of a predetermined number of low-rank processing operations which immediately precede the newly reserved processing operation in a queue of reserved processing operations, in place of reservation statuses of high-rank processing operations which precede the low-rank processing operations in the queue.

3. The display device according to claim 1 or 2, wherein the display means is adapted to display a reservation status of a newly reserved processing operation preferentially in place of a reservation status of a previously reserved processing operation, while displaying an entry screen which permits entry of conditions for a processing operation.

4. A display device according to any of claims 1 to 3, wherein the display device is adapted to display reservation numbers of the reserved processing operations along with their reservation statuses, the reservation statuses being numbered in the order in which the processing operations are reserved.

5. A display device according to any of claims 1 to 4, wherein the display device is adapted to display cancel means for suspending or clearing a reserved processing operation.

6. An image forming apparatus which comprises the display device according to any of claims 1 to 5.
